(19) United States
(12) Patent Application Publication
(10) Pub. No.: US 2026/0317913 A1
(43) Pub. Date: Oct. 15, 2026

(54) ELECTROCHEMICAL CARBON CAPTURE APPARATUS BASED ON SOLID ELECTROLYTE REACTOR, PREPARATION METHOD THEREOF, AND CARBON CAPTURE METHOD

(71) Applicant: THE HONG KONG POLYTECHNIC UNIVERSITY, Hong Kong (CN)

(72) Inventors: Xiao ZHANG, Hong Kong (CN); Yanjie ZHAI, Hong Kong (CN)

(21) Appl. No.: 19/221,034

(22) Filed: May 28, 2025

(30) Foreign Application Priority Data
Apr. 9, 2025 (CN) 202510442838.4

(51) Int. Cl. C25B 1/18; C25B 1/04; C25B 9/19; C25B 11/032; C25B 11/065; C25B 11/081; C25B 13/08

(52) U.S. Cl. CPC C25B 1/18; C25B 1/04; C25B 9/19; C25B 11/032; C25B 11/065; C25B 11/081; C25B 13/08

(57) ABSTRACT

The present application relates to the technical field of carbon capture and environmental protection, and in particular to an electrochemical carbon capture apparatus based on a solid electrolyte reactor, a preparation method, and a carbon capture method. The electrochemical carbon capture apparatus based on the solid electrolyte reactor includes: a porous solid electrolyte layer; a cathode electrode and an anode electrode, respectively arranged on two sides of the porous solid electrolyte layer, the cathode electrode including an oxygen reduction reaction catalyst, and the anode electrode including an oxygen evolution reaction catalyst; a cation exchange membrane, arranged between the cathode electrode and the solid electrolyte layer; a proton exchange membrane, arranged between the anode electrode and the solid electrolyte layer; and a gas diffusion layer, combined with the cathode electrode.

### CROSS-REFERENCE TO RELATED APPLICATIONS

Pursuant to 35 U.S.C. § 119 and the Paris Convention, this application claims the benefit of Chinese Patent Application No. 202510442838.4 filed Apr. 9, 2025, the contents of which are incorporated herein by reference.

### BACKGROUND

### Technical field

The present application relates to the technical field of carbon capture and environmental protection, and in particular to an electrochemical carbon capture apparatus based on a solid electrolyte reactor, a preparation method thereof, and a carbon capture method.

### Description of related art

Anthropogenic carbon dioxide emission is an important driving factor of global warming, and carbon needs to be effectively captured from point sources and diffuse sources (such as direct air capture (DAC)) to mitigate climate change. Conventional DAC methods mainly rely on scrubbing technology, using basic solutions (such as monoethanolamine or hydroxide (KOH/NaOH/Ca(OH)₂)) to absorb carbon dioxide of low concentrations to form carbon-containing compounds, and then release concentrated carbon dioxide for subsequent use. However, this generation process requires a lot of thermal energy, especially for the temperature-variable solvent generation process. In addition, the scrubbing process is complicated due to the need for complex thermal integration with existing infrastructure, degradation of adsorbents at high temperatures, equipment corrosion, and the impact of toxic amine evaporation losses on the environment.

Electrochemical methods provide a sustainable and attractive alternative to conventional thermochemical carbon capture technology. By utilizing renewable electricity as input, these methods can operate efficiently at room temperature, providing an environmentally friendly and decentralized solution to the carbon capture challenge. The typical electrochemical process involves the reduction of redox-active carriers to generate strong bases, which form compounds with electrophilic CO₂ and can be subsequently oxidized to release concentrated CO₂ while generating adsorbents. Although this method is effective, it is often limited by low capture rates and sensitivity to O₂ gas in most CO₂ sources. pH switching methods are another promising approach that exploits the pH sensitivity of carbonaceous solutions, where CO₂ is absorbed at high pH and released at low pH. However, decoupling the electrolysis process from CO₂ absorption requires energy-intensive downstream gas-liquid contacting processes, especially at low CO₂ concentrations. Recent advances in membrane technology have enabled the development of integrated CO₂ capture and release systems that are resistant to O₂ interference. Despite the prospect is promising, challenges still remain. For example, proton exchange membrane-anion exchange membrane (PEMs-AEMs) systems with solid electrolyte layers have achieved continuous CO₂ capture and generation. However, these systems are often plagued by chemical degradation and limited stability, as nucleophilic or radical attacks caused by generated hydroxide ions or carbonates can lead to degradation of AEMs components, ultimately resulting in system operational stability of less than 80 hours. In particular, direct air capture in this system only operates at low current, resulting in low carbon capture rate and air handling capacity.

It can be seen that current carbon capture technologies mainly rely on liquid solvent absorption or high-temperature thermal regeneration to achieve carbon dioxide (CO₂) separation and capture. Such methods generally have high energy consumption and complex equipment requirements, resulting in rising operating costs and difficulty in meeting the growing industrial needs. Liquid solvent capture methods usually use amines or hydroxide solutions, which are quite effective in absorbing CO₂, but require a lot of heat to regenerate the solvent and release the captured CO₂, further increasing energy consumption. In addition, the thermal regeneration process usually requires high temperatures and pressures, which not only accelerate the aging of the equipment and increase maintenance requirements, but also bring higher operational risks. This reduces the long-term stability and service life of the capture system. In addition to the high energy consumption problem, conventional carbon capture technology also has other problems, such as low capture efficiency, high cost, and great impact on the environment. Therefore, it is necessary to find a more efficient, economical, and environmentally friendly carbon capture technology.

### SUMMARY

It is an objective of the present application to provide an electrochemical carbon capture apparatus based on a solid electrolyte reactor, a preparation method thereof, and a carbon capture method, aiming to solve the problem that the prior art cannot capture carbon dioxide at any concentration from various carbon dioxide sources in a long-term, stable, and direct manner.

In order to achieve the above objective, the technical solution adopted by the present application is as follows:

In a first aspect, the present application provides an electrochemical carbon capture apparatus based on a solid electrolyte reactor, comprising:
a porous solid electrolyte layer;
a cathode electrode and an anode electrode, respectively arranged on two sides of the porous solid electrolyte layer, the cathode electrode comprising an oxygen reduction reaction catalyst, and the anode electrode comprising an oxygen evolution reaction catalyst;
a cation exchange membrane, arranged between the cathode electrode and the solid electrolyte layer; a proton exchange membrane, arranged between the anode electrode and the solid electrolyte layer; and
a gas diffusion layer, combined with the cathode electrode.

In some embodiments, a solid electrolyte cation conductor is provided in the porous solid electrolyte layer, and a sodium carbonate solution or a sodium bicarbonate solution is introduced.

In some embodiments, the solid electrolyte cation conductor is selected from a sodium-type styrene-divinylbenzene sulfonic acid copolymer or a Dowex 50W X8 hydrogen-type resin.

In some embodiments, a concentration of the sodium carbonate solution or the sodium bicarbonate solution is between 0.1 mol/L and 1 mol/L.

In some embodiments, the oxygen reduction reaction catalyst is selected from any one of Pt/C and Co-SAC.

In some embodiments, the oxygen evolution reaction catalyst is selected from iridium oxide.

In some embodiments, the gas diffusion layer is selected from a hydrophobic porous carbon-based material.

In some embodiments, the thickness of the gas diffusion layer is between 0.5 mm and 2 mm.

In some embodiments, an operating voltage of the electrochemical carbon capture apparatus is between 0.8 V and 5.0 V, and the operating temperature is between 20 °C and 90 °C.

In a second aspect, the present application provides a preparation method of an electrochemical carbon capture apparatus based on a solid electrolyte reactor. The preparation method comprises the following steps:
spraying a catalyst solution containing an oxygen reduction reaction catalyst on the surface of a cathode material, which is provided with a gas diffusion layer, to obtain a cathode electrode, and spraying a solution containing an oxygen evolution reaction catalyst on the surface of an anode material to obtain an anode electrode; and
providing a porous solid electrolyte layer, a cation exchange membrane, a proton exchange membrane, and gaskets, and arranging the cathode electrode, one of the gaskets, the cation exchange membrane, the porous solid electrolyte layer, the proton exchange membrane, another one of the gaskets, and the anode electrode in sequence, and assembling to obtain an electrochemical carbon capture apparatus.

In a third aspect, the present application provides a carbon capture method using the electrochemical carbon capture apparatus based on the solid electrolyte reactor. The carbon capture method comprises the following steps:
introducing a gas containing carbon dioxide into a cathode side, where oxygen generates hydroxide ions under catalysis of the oxygen reduction reaction catalyst, and the carbon dioxide reacts with the hydroxide ions to generate carbonate or bicarbonate ions;
transporting sodium ions through a proton exchange membrane to the cathode side, where the sodium ions are combined with the carbonate or bicarbonate ions to form sodium carbonate or sodium bicarbonate; and
electrolyzing water at an anode side to generate protons under an oxygen evolution reaction catalyst, and transporting the protons through the porous solid electrolyte layer to a middle layer, so that sodium carbonate or sodium bicarbonate decomposes to release carbon dioxide gas.

In some embodiments, a capture efficiency of the carbon dioxide is ≥80%, and a release purity of the carbon dioxide is ≥98%.

In the electrochemical carbon capture apparatus based on the solid electrolyte reactor provided by the first aspect of the present application, a porous solid electrolyte layer is provided. The provided porous solid electrolyte layer supports continuous operation by promoting the transportation of hydrogen ions and sodium ions. The apparatus further includes a catalyst electrode, which has excellent catalytic activity and stability, is conducive to the occurrence of optimized oxygen reduction reaction and oxygen evolution reaction in the overall reaction, and is conducive to achieving a sufficient reaction rate and maintaining the efficiency of the entire reactor. A gas diffusion layer is also provided at the cathode electrode. The provided gas diffusion layer can improve the carbon dioxide transportation and diffusion efficiency at the electrode interface, ensuring that carbon dioxide molecules can quickly reach the electrocatalytic active site, thereby increasing the reaction rate. A cation exchange membrane and a proton exchange membrane are also provided, which are conducive to the selective ion transportation of sodium and protons, the separation of reaction areas, the maintenance of charge balance, and the realization of continuous operation. The apparatus requires no supplementary chemical reagents, operates without producing harmful by-products, and aligns with sustainable development goals by maximally minimizing environmental impact. Furthermore, the use of robust, corrosion-resistant materials and an optimized reactor design ensures enhanced operational stability and reduced maintenance demands, enabling long-term, reliable performance, which is conducive to wide application.

In the preparation method of an electrochemical carbon capture apparatus based on a solid electrolyte reactor provided by the second aspect of the present application, the preparation method only requires arranging the devices in sequence to assemble an electrochemical carbon capture apparatus based on the solid electrolyte reactor. The preparation method is simple, convenient, and conducive to industrial application.

In the carbon capture method using the electrochemical carbon capture apparatus based on the solid electrolyte reactor provided by the third aspect of the present application, an oxygen reduction reaction occurs at the cathode catalyst-membrane interface to produce OH⁻ ions, which rapidly capture and react with carbon dioxide to form carbonates. Under an applied potential, Na⁺ ions from the middle layer selectively cross the catalytic-exchange membrane into the cathode chamber and associate with the newly formed carbonate, producing sodium carbonate streams. Importantly, the sodium carbonate is then recycled back to the middle chamber without any consumption. Simultaneously, H⁺ ions originating at the boundary of the anode/proton exchange membrane migrate into the middle chamber to replace the Na⁺ ions that have moved into the cathode chamber. After H⁺ is introduced into the middle chamber, the carbonate (bicarbonate) undergoes a decomposition reaction to release a high-purity (≥98%) carbon dioxide flow, thereby completing the carbon capture cycle.

### BRIEF DESCRIPTION OF THE DRAWINGS

In order to more clearly illustrate the technical solutions in the embodiments of the present application, the drawings required for use in the embodiments or prior art descriptions will be briefly introduced below. Obviously, the accompanying drawings in the following description are only some embodiments of the present application. For those skilled in the art, other drawings can be obtained based on these drawings without creative work.

FIG. 1 is a schematic diagram of an electrochemical carbon capture apparatus based on a solid electrolyte reactor provided in an embodiment of the present application.

FIG. 2 is a schematic diagram of a carbon capture method using an electrochemical carbon capture apparatus based on a solid electrolyte reactor provided in an embodiment of the present application.

FIGS. 3A-3B involve schematic diagrams of the carbon capture reaction design and performance provided in an embodiment of the present application. FIG. 3A is a mechanism description of the anode using protons to acidify sodium carbonate and sodium bicarbonate in the middle chamber, FIG. 3B is a schematic diagram of the solid electrolyte reaction design, and FIG. 3C is the corresponding sodium ion Faraday efficiency.

FIG. 4 is a solid electrolyte reactor provided in an embodiment of the present application, in which direct air capture is performed by directly pumping commercial air and real air as carbon sources. FIG. 4A is a photo of a solid electrolyte reactor, where captured CO₂ gas flows out from the middle layer of the solid electrolyte layer, FIG. 4B is a current-voltage curve for electrolysis using commercial air and real air, FIG. 4C is a function of current density with the generation efficiency of carbonate and bicarbonate, and the CO₂ removal rate under commercial air, and FIG. 4D is a stability evaluation of the electrochemical direct air capture (DAC) process at a fixed current of 30 mA/cm² using 400 ppm of real indoor air in a recirculation mode, with an electrode area of 1 cm².

### DETAILED DESCRIPTION OF THE EMBODIMENTS

In order to make the technical problems to be solved in the present application, technical solutions, and beneficial effects clearer, the present application will be further described in detail below in conjunction with the embodiments. It should be understood that the specific embodiments described here are only used to explain the present application, but are not intended to limit the present application.

In the present application, the term “and/or” describes the association relationship of associated objects, indicating that there may be three relationships, for example, A and/or B, which may mean the following conditions: A exists alone, A and B exist simultaneously, and B exists alone. Among them, A and B can be singular or plural. The character “/” generally indicates that the contextual objects have an “or” relationship.

In the present application, “at least one” means one or more, and “multiple” means two or more. “At least one of the following” or similar expressions refer to any combination of these items, including any combination of single or plural items. For example, “at least one of a, b, or c”, or “at least one of a, b, and c” can mean: a, b, c, a-b (that is, a and b), a-c, b-c, or a-b-c, in which, a, b, and c can be singular or plural.

It should be understood that in various embodiments of the present application, the sequence numbers of the above processes do not mean the order of execution, and some or all steps may be executed in parallel or sequentially, and the execution order of each process shall be determined based on its functions and internal logic and should not constitute any limitation to the implementation process of the embodiments of the present application.

Terms used in the embodiments of the present application are only for the purpose of describing specific embodiments, and are not intended to limit the present application. The singular forms “a” and “the” used in the embodiments of the present application and the appended claims are also intended to include plural forms unless otherwise clearly indicated in the context.

The masses of the relevant components mentioned in the embodiments of the present application in the specification can not only refer to the specific contents of the component, but also represent the proportional relationship between the masses of the different components. The scaling up or down of the content of the fraction is within the scope disclosed in the embodiments of the present application in the specification. Specifically, the mass described in the embodiments of the present application in the specification may be μg, mg, g, kg, and other well-known mass units in the chemical industry.

The terms “first” and “second” are adopted for descriptive purposes only to distinguish different substances and are not to be construed as indicating or implying a relative importance or implicitly indicating the number of technical features indicated. For example, without departing from the scope of the embodiments of the present application, the first XX can also be referred to as the second XX, and similarly, the second XX can also be referred to as the first XX. Thus, features prefixed by “first” and “second” will explicitly or implicitly represent that one or more of the referred technical features are included.

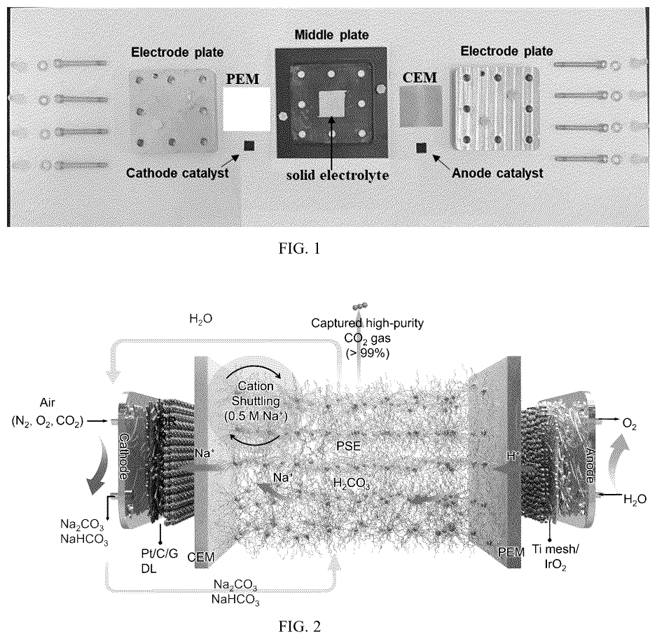

A first aspect of embodiments of the present application provides an electrochemical carbon capture apparatus based on a solid electrolyte reactor, as shown in FIG. 1, comprising:
a porous solid electrolyte layer;
a cathode electrode and an anode electrode, respectively arranged on two sides of the porous solid electrolyte layer, the cathode electrode comprising an oxygen reduction reaction catalyst, and the anode electrode comprising an oxygen evolution reaction catalyst;
a cation exchange membrane, arranged between the cathode electrode and the solid electrolyte layer;
a proton exchange membrane, arranged between the anode electrode and the solid electrolyte layer; and
a gas diffusion layer, combined with the cathode electrode.

In the electrochemical carbon capture apparatus based on the solid electrolyte reactor provided by the first aspect of the present application, a porous solid electrolyte layer is provided. The provided porous solid electrolyte layer supports continuous operation by promoting the transportation of hydrogen ions and sodium ions. The apparatus further includes a catalyst electrode, which has excellent catalytic activity and stability, is conducive to the occurrence of optimized oxygen reduction reaction and oxygen evolution reaction in the overall reaction, and is conducive to achieving a sufficient reaction rate and maintaining the efficiency of the entire reactor. A gas diffusion layer is also provided at the cathode electrode. The provided gas diffusion layer can improve the carbon dioxide transportation and diffusion efficiency at the electrode interface, ensuring that carbon dioxide molecules can quickly reach the electrocatalytic active site, thereby increasing the reaction rate. A cation exchange membrane and a proton exchange membrane are also provided, which are conducive to the selective ion transportation of sodium and protons, the separation of reaction areas, the maintenance of charge balance, and the realization of continuous operation. The apparatus requires no supplementary chemical reagents, operates without producing harmful by-products, and aligns with sustainable development goals by maximally minimizing environmental impact. Furthermore, the use of robust, corrosion-resistant materials and an optimized reactor design ensures enhanced operational stability and reduced maintenance demands, enabling long-term, reliable performance, which is conducive to wide application.

The porous solid electrolyte layer provided is a solid electrolyte, which is generally more stable and less prone to degradation than liquid solvents, which can evaporate or decompose over time. The porous solid electrolyte is more durable, reducing the need for frequent replacement and maintenance, thereby enhancing the reactor's reliability. The solid electrolyte has a simpler and safer design, and the elimination of liquid electrolytes reduces the complexity of system design, as there is no need for liquid handling equipment or containment measures for spills and leaks. This simplification leads to a reactor with fewer parts and a simpler overall design, making it easier to manufacture and operate. In addition, solid-state nature of the electrolyte allows for easier integration into the reactor assembly, potentially reducing manufacturing costs compared to systems that require complex liquid management components.

In some embodiments, a solid electrolyte cation conductor is provided in the porous solid electrolyte layer, and a sodium carbonate solution or a sodium bicarbonate solution is introduced.

In some embodiments, the porous solid electrolyte layer is made of styrene-divinylbenzene sulfonated copolymer and is functionalized by introducing a solid electrolyte cation conductor, which has the characteristics of being porous, water-permeable, air-permeable, and Na⁺ conductive. This layer is critical for the nucleation of carbon dioxide bubbles and Na⁺ transport.

Further, a sodium carbonate solution or a sodium bicarbonate solution is introduced as a circulating medium to circulate between the cathode and the middle chamber. At the cathode catalyst-membrane interface, the OH⁻ ions generated by the oxygen reduction reaction (ORR) quickly capture CO₂ and generate carbonate or bicarbonate ions. Under an applied potential, the Na⁺ ions from the middle layer selectively cross the anion exchange membrane (CEM) into the cathode chamber and associate with the generated (carbonate or bicarbonate) to generate a sodium carbonate solution or a sodium bicarbonate solution. It is worth noting that the generated sodium carbonate solution or sodium bicarbonate solution is circulated back to the middle chamber without any consumption. Simultaneously, the H⁺ ions generated at the anode/proton exchange membrane (PEM) interface migrate to the middle chamber to replace the Na⁺ ions entering the cathode chamber. In the middle chamber, the sodium bicarbonate solution is decomposed to release high-purity CO₂.

In some embodiments, the solid electrolyte cation conductor is selected from a sodium-type styrene-divinylbenzene sulfonic acid copolymer or a Dowex 50W X8 hydrogen-type resin.

In some embodiments, a concentration of the sodium carbonate solution or the sodium bicarbonate solution is between 0.1 mol/L and 1 mol/L. During the migration of Na⁺, H⁺ is simultaneously generated at the anode, and then migrates to the middle chamber under the action of the electric field. The migrated H⁺ acidifies the carbonate or bicarbonate solution in the middle chamber, resulting in the generation of CO₂. Therefore, the form of the carbonaceous solution in the middle layer, that is, carbonate or bicarbonate, plays a crucial role in the efficiency of CO₂ release under this condition. Through experiments in specific embodiments, it can be found that at the same operating current, by using 0.5 M NaHCO₃ (0.5 M Na⁺), the system achieved a CO₂ generation rate of 16.31 mmol cm⁻² h⁻¹ at 500 mA cm⁻². In contrast, carbonate needs to be further acidified to NaHCO₃ to generate CO₂, which doubles the energy consumption. Using 0.25 M Na₂CO₃ solution (0.5 M Na⁺), the system still maintained a high (>90%) Faradaic efficiency and a CO₂ generation rate of 8.23 mmol mmol cm⁻² h⁻¹ at 500 mA cm⁻². Notably, under the same current conditions, the presence of bicarbonate in the middle chamber doubled the CO₂ generation rate compared to carbonate. It should be noted that the carbonate or bicarbonate here is directly supplied, but our ultimate goal is to develop a closed-loop system in which carbonate or bicarbonate is formed from CO₂ captured at the cathode and then recycled back to the middle chamber.

In some specific embodiments, the concentration of the sodium carbonate solution or sodium bicarbonate solution includes, but is not limited to, typical but non-limiting values such as 0.1 mol/L, 0.2 mol/L, 0.3 mol/L, 0.4 mol/L, 0.5 mol/L, 0.6 mol/L, 0.7 mol/L, 0.8 mol/L, 0.9 mol/L, and 1.0 mol/L.

In some embodiments, 200 mL of NaHCO₃ solution is circulated between the porous solid electrolyte layer and the cathode chamber, maintaining a flow rate of 0.8-1.0 mL/min. In some specific embodiments, 200 mL of NaHCO₃ solution is circulated between the porous solid electrolyte layer and the cathode chamber, maintaining a flow rate of 0.9 mL/min.

Further, high-performance catalyst electrodes are conducive to enhanced reaction rates and efficiencies: using high-performance catalysts such as platinum on carbon (Pt/C) as the cathode catalyst and iridium oxide (IrO₂) as the anode catalyst can significantly accelerate oxygen reduction and oxygen evolution reactions. This leads to faster CO₂ capture and higher overall efficiency than systems using less effective catalysts. Therefore, it can be seen that high-performance catalyst electrodes are highly resistant to corrosion and degradation, which enhances the durability of the electrode and ensures consistent performance over time. In addition, the high activity of these catalysts allows for more precise control of the electrochemical reaction, making the system more accurate and predictable in operation.

In some embodiments, the oxygen reduction reaction catalyst is selected from any one of Pt/C and Co-SAC. With an effective oxygen reduction reaction catalyst and sufficient CO₂ at the gas diffusion layer (GDL) interface, one sodium bicarbonate is formed for each electron transfer (one CO₂ molecule is captured for each electron transferred).

In some embodiments, the oxygen evolution reaction catalyst is selected from iridium oxide.

In some embodiments, an effective electrode area of the oxygen reduction reaction catalyst is 1 cm². An effective electrode area of the oxygen evolution reaction catalyst is 1 cm².

In some embodiments, the gas diffusion layer is selected from a hydrophobic porous carbon-based material.

In some embodiments, thickness of the gas diffusion layer is between 0.5 mm and 2 mm. In some specific embodiments, the thickness of the gas diffusion layer includes, but is not limited to, typical but non-limiting values such as 0.5 mm, 0.7 mm, 1 mm, 1.2 mm, 1.5 mm, 1.7 mm, and 2 mm.

In addition, a proton ion exchange membrane and a cation exchange membrane are provided, providing a proton exchange membrane (PEM) and an anion exchange membrane (CEM) that can achieve selective exchange of ions—that is, selective exchange of protons (H⁺) and cations (such as Na⁺)—which is crucial for maintaining charge balance and achieving efficient electrochemical reactions. This selective transport is more accurate and reliable than systems without such membranes. In addition, by effectively separating the anodic and cathodic regions, the membranes can prevent cross-contamination of gases and ions, ensuring that high-purity carbon dioxide can be generated without additional purification steps and reducing operational complexity. The use of PEM and CEM membranes can reduce the number of components needed to manage ion transport and separation, resulting in a simpler and more compact reactor design and reducing the number of parts.

In some embodiments, an operating voltage of the electrochemical carbon capture apparatus is between 0.8 V and 5.0 V, and the operating temperature is between 20 °C and 90 °C.

In some embodiments, the electrochemical carbon capture apparatus based on the solid electrolyte reactor can be modularly designed. The modular design enables the reactor system to be easily scaled up or down to meet specific industrial needs. Modules can be added or removed without redesigning the entire system, offering greater flexibility than monolithic reactors. Modules can be mass-produced and assembled on-site, reducing production complexity and cost. This makes the system cheaper to manufacture and simpler to install. Individual modules can be serviced or replaced without affecting the entire system. This reduces downtime and maintenance costs and allows for easy integration of technological advancements. The modular reactor has fewer parts per unit, which can simplify the control system and make the entire system simpler and more reliable.

The device can be designed to accommodate varying CO₂ concentrations and sources according to different sources of carbon dioxide, making it suitable for diverse industrial applications.

The second aspect of embodiments of the present application provides a preparation method of an electrochemical carbon capture apparatus based on a solid electrolyte reactor, comprising the following steps:
S01. spraying a catalyst solution containing an oxygen reduction reaction catalyst on a surface of a cathode material, which is provided with a gas diffusion layer, to obtain a cathode electrode, and spraying a solution containing an oxygen evolution reaction catalyst on a surface of an anode material to obtain an anode electrode; and
S02. providing a porous solid electrolyte layer, a cation exchange membrane, a proton exchange membrane, and gaskets, and arranging the cathode electrode, one of the gaskets, the cation exchange membrane, the porous solid electrolyte layer, the proton exchange membrane, another one of the gaskets, and the anode electrode in sequence, and assembling to obtain an electrochemical carbon capture apparatus.

In the preparation method of an electrochemical carbon capture apparatus based on a solid electrolyte reactor provided by the second aspect of the present application, the preparation method only requires arranging the devices in sequence to assemble an electrochemical carbon capture apparatus based on the solid electrolyte reactor. The preparation method is simple, convenient, and conducive to industrial application.

In step S01, a catalyst solution containing an oxygen reduction reaction catalyst is sprayed on a surface of a cathode material, which is provided with a gas diffusion layer, to obtain a cathode electrode, and then a solution containing an oxygen evolution reaction catalyst is sprayed on a surface of an anode material to obtain an anode electrode.

It is necessary to select a material with high oxygen reduction and water oxidation catalytic properties. Platinum on carbon (Pt/C) and iridium oxide (IrO₂) are selected as catalysts because they have excellent catalytic properties and durability. These catalysts are essential for optimizing the oxygen reduction reaction (ORR) and oxygen evolution reaction (OER) processes in the reactor.

To prepare the cathode electrode, the selected catalyst (e.g., Pt/C), 4 mL of 2-propanol (isopropanol), and 160 μL of a 5% Nafion binder solution were mixed to form a catalyst solution with a concentration of approximately 10.0 mg/mL, which was sonicated for 30 minutes to ensure uniformity. The resulting ink was then spray coated on a 5×5 cm² Sigracet 28 BC gas diffusion layer (GDL) electrode to prepare the cathode electrode.

IrO₂ was used as a catalyst for the anode electrode and was also prepared similarly to ensure a uniform and effective catalyst layer. This electrode configuration is designed to optimize the ORR/OER reduction-oxidation reaction, forming a highly alkaline environment that promotes CO₂ adsorption and carbonate ion generation. The use of highly conductive and corrosion-resistant materials ensures long-term stability and performance of the electrode.

In some embodiments, the gas diffusion layer plays a key role in enhancing the efficiency of carbon dioxide transport and diffusion at the electrode interface, ensuring that carbon dioxide molecules can quickly reach the electrocatalytic active sites, thereby increasing the reaction rate. The gas diffusion layer is usually made of a hydrophobic porous carbon-based material to promote gas flow while preventing electrode clogging.

During the electrode preparation process, the catalyst ink is spray-coated on the gas diffusion layer to integrate it into the electrode assembly. The porous structure of the gas diffusion layer enables the carbon dioxide gas to be evenly distributed and diffused in the catalyst layer, maximizing contact with active sites, thereby improving the efficiency of the entire reactor.

This electrode configuration is designed to optimize the ORR/OER reduction-oxidation reaction and form a highly alkaline environment that promotes carbon dioxide adsorption and carbonate ion generation. The use of highly conductive and corrosion-resistant materials can ensure the long-term stability and performance of the electrode.

In step S02, a porous solid electrolyte layer, a cation exchange membrane, a proton exchange membrane, and gaskets are provided; and the cathode electrode, one of the gaskets, the cation exchange membrane, the porous solid electrolyte layer, the proton exchange membrane, another one of the gaskets, and the anode electrode are arranged and assembled in sequence to obtain an electrochemical carbon capture apparatus.

In some embodiments, a 0.5 mm-thick polytetrafluoroethylene gasket with a window area of 1.0 cm² is placed between the cathode electrode and the solid electrolyte layer, and a cation exchange membrane (CEM) is also placed to separate the cathode chamber from the solid electrolyte chamber.

The middle solid electrolyte chamber is composed of a 2.0 mm-thick plastic frame filled with Dowex 50W X8 hydrogen-type solid electrolyte resin to ensure high ion conductivity.

On the anode side, a Nafion 117 film is placed as a proton exchange membrane (PEM), and a second PTFE gasket is also placed, using IrO₂ as an anode catalyst for OER.

This configuration enables efficient exchange of sodium ions and protons, ensures high-purity carbon dioxide release, and enables continuous operation without additional chemical reagents or heat input.

Further, the shell of the electrochemical carbon capture apparatus product based on the solid electrolyte reactor provided can be arbitrarily placed and deformed into other shapes. A larger shell can convert low-concentration carbon dioxide into high-concentration carbon dioxide. The smaller case makes it easier for users to use and store it.

A third aspect of embodiments of the present application provides a carbon capture method using the electrochemical carbon capture apparatus based on the solid electrolyte reactor, as shown in FIG. 2, comprising the following steps:
G01. introducing a gas containing carbon dioxide into the cathode side, where oxygen generates hydroxide ions under catalysis of the oxygen reduction reaction catalyst, and the carbon dioxide reacts with the hydroxide ions to generate carbonate or bicarbonate ions;
G02. transporting sodium ions through a proton exchange membrane to the cathode side, where the sodium ions are combined with the carbonate or bicarbonate ions to form sodium carbonate or sodium bicarbonate; and
G03. electrolyzing water at the anode side to generate protons under an oxygen evolution reaction catalyst, and transporting the protons through the porous solid electrolyte layer to a middle layer, so that sodium carbonate or sodium bicarbonate decomposes to release carbon dioxide gas.

In the carbon capture method using the electrochemical carbon capture apparatus based on the solid electrolyte reactor provided by the third aspect of the present application, an oxygen reduction reaction occurs at the cathode catalyst-membrane interface to produce OH⁻ ions, which rapidly capture and react with carbon dioxide to form carbonate or bicarbonate. Under an applied potential, Na⁺ ions from the middle layer selectively cross the catalytic-exchange membrane into the cathode chamber and associate with the newly formed carbonate or bicarbonate to produce sodium carbonates or bicarbonate streams. Importantly, the sodium carbonate or the sodium bicarbonate is then recycled back to the middle chamber without any consumption. Simultaneously, H⁺ ions originating at the boundary of the anode/proton exchange membrane migrate into the middle chamber to replace the Na⁺ ions that have moved into the cathode chamber. After H⁺ is introduced into the middle chamber, the sodium carbonate or bicarbonate undergoes a decomposition reaction to release a high-purity (≥98%) carbon dioxide flow, thereby completing the carbon capture cycle.

In step G01, a gas containing carbon dioxide is introduced into the cathode side, where oxygen generates hydroxide ions under catalysis of the oxygen reduction reaction catalyst, and the carbon dioxide reacts with the hydroxide ions to generate carbonate or bicarbonate ions.

The gas containing carbon dioxide provided includes, but is not limited to, air or flue gas containing carbon dioxide.

The reactor operates based on electrochemical reactions occurring at the cathode and anode. At the cathode, an oxygen reduction reaction (ORR) occurs, where oxygen is reduced to generate hydroxide ions (OH⁻), thereby creating an alkaline environment that is conducive to carbon dioxide capture: O₂+2H₂O+4e⁻→4OH⁻.

Further, carbon dioxide molecules react with hydroxide ions to form carbonate or bicarbonate ions: CO₂+2OH⁻→CO₃²⁻+H₂O; CO₃⁻+CO₂+H₂O→2HCO₃⁻.

In step G02, sodium ions are transported through a proton exchange membrane to the cathode side, where the sodium ions are combined with the carbonate or bicarbonate ions to form sodium carbonate or sodium bicarbonate.

The transported sodium ions react with bicarbonate ions to form sodium bicarbonate: Na⁺+HCO₃⁻→NaHCO₃.

In step G03, water at an anode side is electrolyzed to generate protons under an oxygen evolution reaction catalyst, and the protons are transported through the porous solid electrolyte layer to a middle layer, so that sodium carbonate or sodium bicarbonate decomposes to release carbon dioxide gas. Simultaneously, hydroxide ions are regenerated at the cathode, completing the entire electrochemical cycle. This process achieves continuous carbon dioxide capture and release, and the captured carbonate ions can be efficiently converted into carbon dioxide gas in the middle chamber. The efficient ion exchange achieved by CEM and PEM ensures electrical neutrality and supports the continuous operation of the reactor.

This carbon capture method has a wide range of applications, especially for direct air capture (DAC) and flue gas carbon capture, and can directly extract high-purity carbon dioxide from ambient air. The modular design allows for scalability, making it feasible to deploy multiple reactor units to meet varying DAC demands. Furthermore, the system operates without additional chemical reagents, reducing environmental impact and operating costs. The high-purity carbon dioxide produced can be utilized in various industrial applications, thereby providing a versatile and sustainable solution for greenhouse gas emission reduction. The high energy consumption of the reactor improves its economic viability, making DAC a practical and attractive option for achieving carbon neutrality to support global climate change initiatives.

The device can be operated by directly capturing carbon dioxide from the air, which guarantees lower costs. Conventional direct air capture systems rely on complex components and expensive chemical reagents. By introducing a porous solid electrolyte layer, high-performance catalyst electrodes, and ion-selective membranes (PEM and CEM), the system eliminates the need for expensive chemicals and thermal regeneration processes. This simplification reduces manufacturing complexity, lowers capital and operating costs, and reduces maintenance and energy consumption.

Capturing CO₂ from air, which contains only a few million parts per million (ppm), is inherently challenging. The high-performance catalyst electrodes create a strong alkaline environment that quickly converts CO₂ into carbonate or bicarbonate ions. Meanwhile, the porous solid electrolyte layer optimizes ion transport and ensures uniform reaction conditions. This controlled electrochemical environment enables more accurate and efficient capture of CO₂ from low-concentration sources, avoiding the inefficiencies and fluctuations found in conventional solvent-based direct air capture systems. More reliable and durable over time: Conventional carbon capture systems use strong chemical solvents and operate at high temperatures, leading to accelerated equipment wear and reduced system lifespan.

In contrast, the embodiments of the present application use corrosion-resistant materials, strong catalysts, and solid electrolytes, operate stably under normal temperature conditions, and perform continuous cycles without consumption. This durable design results in fewer part replacements and more reliable long-term performance.

Existing carbon capture equipment typically contains multiple pumps, heaters, cooling systems, and large volumes of chemical adsorbents, which increases complexity and cost. The embodiments of the present application introduce integrated membranes, modular solid-state components, and simplified reactor designs, which greatly reduce the number of parts and auxiliary equipment. Fewer parts lead to simpler assembly, easier maintenance, and a more compact footprint, collectively lowering operational complexity and overall system costs.

Currently existing carbon capture technologies produce hazardous by-products and require solvent regeneration, which poses environmental and operational challenges. The embodiments of the present application eliminate the solvent regeneration step by relying on clean electrochemical processes that do not produce hazardous by-products and require no additional chemical inputs. In addition, the system consumes less energy, directly mitigating environmental concerns and contributing to a cleaner, more sustainable carbon capture strategy.

The modular flexibility provided by the embodiments of the present application ensures that the system can handle different CO₂ concentrations and can be seamlessly integrated into diverse industrial settings or stand-alone direct air capture plants. The adaptability of the design overcomes the complexity and cost barriers of current technologies, making it suitable for a wide range of applications and facilitating large-scale deployment.

Further, the reactor provided in the present application can be modularly configured, providing excellent scalability and facilitating adaptation to various carbon dioxide concentrations and emissions changes in different industrial environments. In addition, its efficient carbon dioxide conversion and separation process can produce high-purity carbon dioxide, which is suitable for advanced applications such as carbon dioxide emission reduction, carbon dioxide hydrogenation, organic synthesis reactions or storage efforts, thereby expanding the practicality and market value of the system.

In some embodiments, a capture efficiency of the carbon dioxide is ≥80%, and a release purity of the carbon dioxide is ≥98%.

The following is an explanation in conjunction with specific examples.

### Example 1

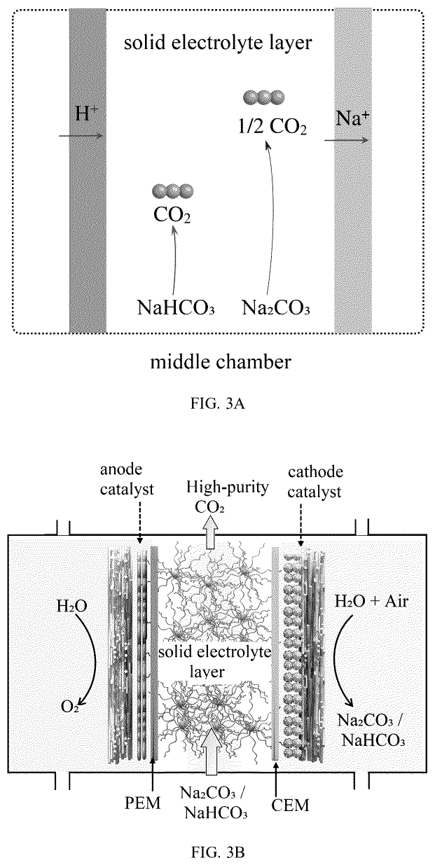

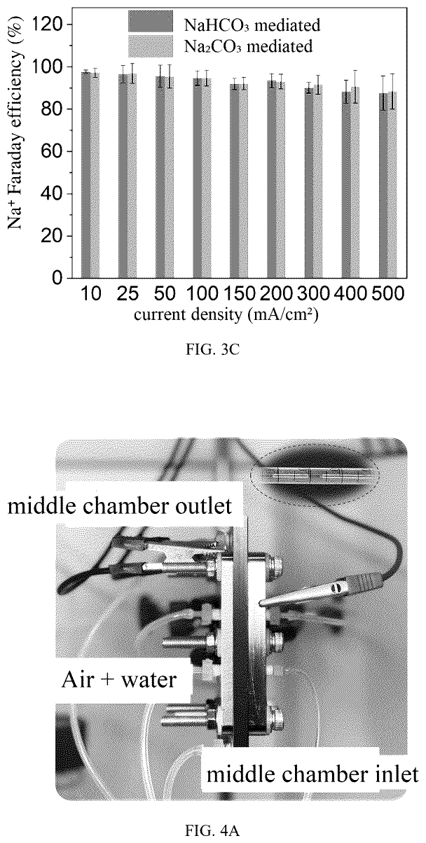

### Electrochemical Carbon Capture Apparatus Based on Solid Electrolyte Reactor and Preparation Method Thereof (FIG. 3B)

(1) The apparatus comprises:
a porous solid electrolyte layer, in which, a Dowex 50W X8 hydrogen-type resin is adopted as a solid electrolyte cation conductor, and a 0.5 mol/L sodium bicarbonate solution is introduced to enable 200 ml of NaHCO₃ solution is circulated between the porous solid electrolyte layer and a cathode chamber, with a flow rate of 0.9 mL/min;
a cathode electrode and an anode electrode, which are respectively arranged on both sides of the porous solid electrolyte layer, in which the cathode electrode comprises an oxygen reduction reaction catalyst Pt/C, and the anode electrode comprises an oxygen evolution reaction catalyst iridium oxide;
a cation exchange membrane, which is arranged between the cathode electrode and the solid electrolyte layer; a proton exchange membrane, which is arranged between the anode electrode and the solid electrolyte layer; and
a gas diffusion layer, which is selected from a hydrophobic porous carbon-based material, combined with the cathode electrode, in which the thickness of the gas diffusion layer is 0.5 mm.
(2) The preparation method of the electrochemical carbon capture apparatus based on the solid electrolyte reactor is performed by the following steps:
a catalyst solution containing an oxygen reduction reaction catalyst is sprayed on the surface of a cathode material, which is provided with a gas diffusion layer, to obtain a cathode electrode, and then a solution containing an oxygen evolution reaction catalyst is sprayed on the surface of an anode material to obtain an anode electrode.
a porous solid electrolyte layer, a cation exchange membrane, a proton exchange membrane, and gaskets are provided; and the cathode electrode, one of the gaskets, the cation exchange membrane, the porous solid electrolyte layer, the proton exchange membrane, another one of the gaskets, and the anode electrode are arranged and assembled in sequence to obtain an electrochemical carbon capture apparatus.
(3) A carbon capture method using the electrochemical carbon capture apparatus based on the solid electrolyte reactor is performed by the following steps:
a gas containing carbon dioxide is introduced into the cathode side, where oxygen generates hydroxide ions under the catalysis of the oxygen reduction reaction catalyst, and the carbon dioxide reacts with the hydroxide ions to generate carbonate or bicarbonate ions;
sodium ions are transported through a proton exchange membrane to the cathode side, where the sodium ions are combined with the carbonate or bicarbonate ions to form sodium carbonate or sodium bicarbonate;
water at an anode side is electrolyzed to generate protons under an oxygen evolution reaction catalyst, and the protons are transported through the porous solid electrolyte layer to a middle layer, so that sodium carbonate or sodium bicarbonate decomposes to release carbon dioxide gas. (FIG. 3A)
(4) Electrochemical performance test and DAC verification: After the operation steps of Example 1 are completed, a system test machine will be carried out for systematic evaluation. The sodium ion shuttle rate of the entire reaction is maintained at more than 80% (FIG. 3C).

### Example 2

### Direct Air Capture (DAC) in Simulated and Real Air in Hong Kong

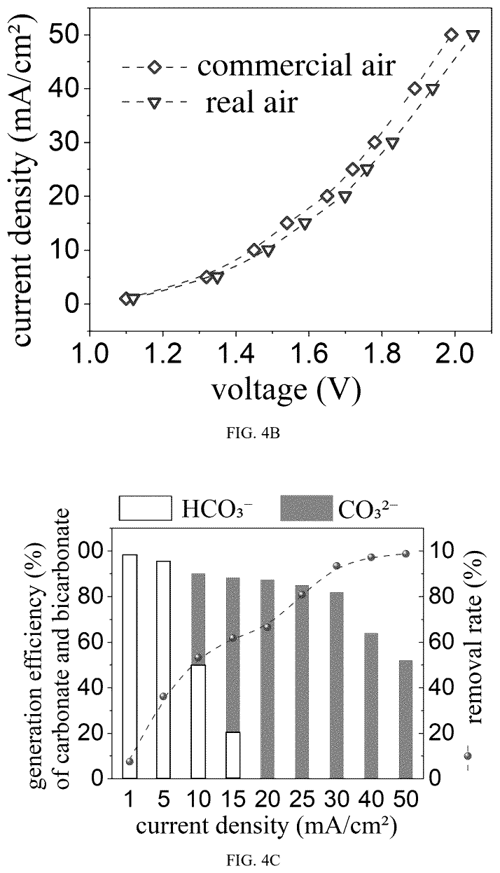

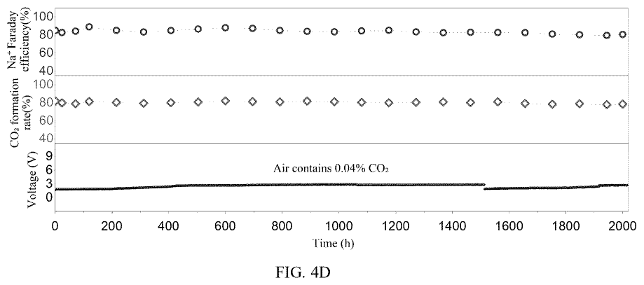

Compressed air (with a CO₂ concentration of 400 ppm) and real indoor air (air from Hung Hom, Kowloon, Hong Kong) were used as gas sources. Instead of using enriched gas mixtures such as CO₂+O₂ or CO₂+air mixtures, this air was directly introduced into our PSE reactor, specifically designed for efficient CO₂ capture. By using realistic air composition, we aim to demonstrate the feasibility of our system under realistic operating conditions and determine the optimal conditions that achieve both high carbon removal efficiency and high CO₂ capture rate. We use a gas-liquid separation device to collect the generated CO₂ gas and fill the gas and liquid from the middle chamber into an empty burette (FIG. 4A). This setup enables accurate quantification of the generated CO₂, thereby ensuring the reliability of the performance indicators.

As shown in FIG. 4B, at the same current density, the voltages required to capture compressed air and real indoor air are similar, which shows the robustness of our approach.

The system was operated under different air sources. When the CO₂ concentration is reduced to about 400 ppm, mass transfer becomes a key factor in determining the overall carbon capture performance. This limitation is inherent when dealing with low concentrations of CO₂, as the mass transfer rate of CO₂ molecules to the reaction site becomes a bottleneck. To evaluate the performance of the prototype under more stringent conditions that are relevant to practical applications, the rate of CO₂ removal from air, which is critical for direct air capture (DAC), was also evaluated. As shown in FIG. 4C, in the direct flow model, by pumping a mixture of air and atomized water, the carbonate generation rate (equal to the CO₂ capture rate) increases almost linearly in the low oxygen reduction reaction current density range (1-30 mA/cm²) and decreases slightly at high current densities (30-50 mA/cm²). When capturing 400 ppm of CO₂ in the reactor of the carbon capture apparatus, the alkaline solution is completely composed of sodium bicarbonate at current densities below 5 mA/cm²; sodium bicarbonate accounts for 51% at 10 mA/cm²; and sodium carbonate becomes the main component above 20 mA/cm². Although the proportion of bicarbonate generation remains above 80% at low current densities, the CO₂ removal rate is low. At a current density of 30 mA/cm² , the reactor achieved a 94% CO₂ removal rate and over 82% carbonate formation rate, demonstrating efficient carbon capture even at low CO₂ concentrations. When the current density was increased to 40-50 mA/cm², the removal rate exceeded 95%, but the carbonate formation rate dropped to below 70%. As expected, there is a trade-off between CO₂ removal rate and carbonate formation rate, increasing the ORR current density reduces carbonate formation rate due to CO₂ mass transfer limitations under direct air capture (DAC) conditions. 30 mA/cm² was chosen for stability testing to achieve a high removal rate and carbonate formation rate. The superior performance of Co-SAC compared to Pt/C highlights its potential as an effective catalyst for direct air capture (DAC) applications, combining high efficiency and cost advantages compared to precious metal catalysts. Most importantly, we ran the cell for more than 2000 hours of continuous testing of the DAC using real indoor air at a fixed current density of 30 mA/cm² , and observed no significant decrease in CO₂ generation efficiency (about 85% to 75%) and cell voltage (about 2.0 V) (FIG. 4D). This long-term stability test shows that the PSE system has excellent durability, making it suitable for continuous DAC operation.

In summary, the examples of the present application present a new method for manufacturing an efficient and scalable solid electrolyte reactor. This solid electrolyte reactor comprises a porous solid electrolyte layer combined with an oxygen reduction reaction (ORR) and oxygen evolution reaction (OER) electrode system. By optimizing the structure and ion transport pathways, the reactor enables continuous adsorption of a broad concentration of carbon dioxide, ranging from air to high CO₂ concentrations. The system not only achieves superior capture efficiency but also addresses common drawbacks in current technologies, such as poor long-term stability and high operating costs. The present application is particularly suitable for large-scale industrial applications, offering a cost-effective, durable, and environmentally responsible solution to reduce greenhouse gas emissions and meet stringent sustainability targets.

The above are only preferred examples of the present application and are not intended to limit the present application. Any modifications, equivalent substitutions, and improvements made within the spirit and principles of the present application shall be included in the scope of protection of the present application.

What is claimed is:

1. An electrochemical carbon capture apparatus based on a solid electrolyte reactor, comprising:
a porous solid electrolyte layer;
a cathode electrode and an anode electrode, respectively arranged on two sides of the porous solid electrolyte layer, the cathode electrode comprising an oxygen reduction reaction catalyst, and the anode electrode comprising an oxygen evolution reaction catalyst;
a cation exchange membrane, arranged between the cathode electrode and the solid electrolyte layer;
a proton exchange membrane, arranged between the anode electrode and the solid electrolyte layer; and
a gas diffusion layer, combined with the cathode electrode.

2. The electrochemical carbon capture apparatus based on the solid electrolyte reactor according to claim 1, wherein a solid electrolyte cation conductor is provided in the porous solid electrolyte layer, and a sodium carbonate solution or a sodium bicarbonate solution is introduced.

3. The electrochemical carbon capture apparatus based on the solid electrolyte reactor according to claim 2, wherein
the solid electrolyte cation conductor is selected from a sodium-type styrene-divinylbenzene sulfonic acid copolymer or a Dowex 50W X8 hydrogen-type resin.

4. The electrochemical carbon capture apparatus based on the solid electrolyte reactor according to claim 2, wherein
a concentration of the sodium carbonate solution or the sodium bicarbonate solution is between 0.1 mol/L and 1 mol/L.

5. The electrochemical carbon capture apparatus based on the solid electrolyte reactor according to claim 1, wherein
the oxygen reduction reaction catalyst is selected from any one of Pt/C and Co-SAC.

6. The electrochemical carbon capture apparatus based on the solid electrolyte reactor according to claim 1, wherein
the oxygen evolution reaction catalyst is selected from iridium oxide.

7. The electrochemical carbon capture apparatus based on the solid electrolyte reactor according to claim 1, wherein the gas diffusion layer is selected from a hydrophobic porous carbon-based material.

8. The electrochemical carbon capture apparatus based on the solid electrolyte reactor according to claim 7, wherein a thickness of the gas diffusion layer is between 0.5 mm and 2 mm.

9. The electrochemical carbon capture apparatus based on the solid electrolyte reactor according to claim 1, wherein an operating voltage of the electrochemical carbon capture apparatus is between 0.8 V and 5.0 V, and an operating temperature of the electrochemical carbon capture apparatus is between 20 °C and 90 °C.

10. A preparation method of the electrochemical carbon capture apparatus based on the solid electrolyte reactor according to claim 1, comprising the following steps:
spraying a catalyst solution containing the oxygen reduction reaction catalyst on a surface of a cathode material provided with the gas diffusion layer to obtain the cathode electrode, and spraying a solution containing the oxygen evolution reaction catalyst on a surface of an anode material to obtain the anode electrode; and
providing the porous solid electrolyte layer, the cation exchange membrane, the proton exchange membrane, and gaskets, and arranging the cathode electrode, one of the gaskets, the cation exchange membrane, the porous solid electrolyte layer, the proton exchange membrane, another one of the gaskets, and the anode electrode in sequence, and assembling to obtain the electrochemical carbon capture apparatus.

11. A carbon capture method using the electrochemical carbon capture apparatus based on the solid electrolyte reactor according to claim 1, comprising the following steps:
introducing a gas containing carbon dioxide into a cathode side, where oxygen generates hydroxide ions under the catalysis of the oxygen reduction reaction catalyst, and the carbon dioxide reacts with the hydroxide ions to generate carbonate or bicarbonate ions;
transporting sodium ions through a proton exchange membrane to the cathode side, where the sodium ions are combined with the carbonate or bicarbonate ions to form sodium carbonate or sodium bicarbonate; and
electrolyzing water at an anode side to generate protons under an oxygen evolution reaction catalyst, and transporting the protons through the porous solid electrolyte layer to a middle layer, so that sodium carbonate or sodium bicarbonate decomposes to release carbon dioxide gas.

12. The carbon capture method according to claim 11, wherein a capture efficiency of carbon dioxide is ≥80%, and a release purity of the carbon dioxide is ≥98%.

13. The carbon capture method according to claim 11, wherein a solid electrolyte cation conductor is provided in the porous solid electrolyte layer, and a sodium carbonate solution or a sodium bicarbonate solution is introduced.

14. The carbon capture method according to claim 13, wherein
the solid electrolyte cation conductor is selected from a sodium-type styrene-divinylbenzene sulfonic acid copolymer or a Dowex 50W X8 hydrogen-type resin.

15. The carbon capture method according to claim 13, wherein a concentration of the sodium carbonate solution or the sodium bicarbonate solution is between 0.1 mol/L and 1 mol/L.

16. The carbon capture method according to claim 11, wherein the oxygen reduction reaction catalyst is selected from any one of Pt/C and Co-SAC.

17. The carbon capture method according to claim 11, wherein the oxygen evolution reaction catalyst is selected from iridium oxide.

18. The carbon capture method according to claim 11, wherein the gas diffusion layer is selected from a hydrophobic porous carbon-based material.

19. The carbon capture method according to claim 18, wherein a thickness of the gas diffusion layer is between 0.5 mm and 2 mm.

20. The carbon capture method according to claim 11, wherein an operating voltage of the electrochemical carbon capture apparatus is between 0.8 V and 5.0 V, and an operating temperature of the electrochemical carbon capture apparatus is between 20 °C and 90 °C.
